(19) United States
(12) Patent Application Publication
(10) Pub. No.: US 2004/0129439 A1
(43) Pub. Date: Jul. 8, 2004

(54) EMI suppressing cable

(76) Inventors: Takaki Tsutsui, Tokyo (JP); Tomonori Nakata, Tokyo (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/739,142

(22) Filed: Dec. 19, 2003

(30) Foreign Application Priority Data
Dec. 24, 2002 (JP) P.2002-372780

(51) Int. Cl. H01B 7/29

(52) U.S. Cl. 174/36

(57) ABSTRACT

An EMI suppressing cable, includes a core wire bundle, a shielding layer and a sheath layer. The core wire bundle includes a plurality of core wires respectively covered with insulative covering layers, and ferrite compound-mixed resin layers are respectively covering the insulative covering layers. The shielding layer covers the core wire bundle. The sheath layer covers the shielding layer.

### BACKGROUND OF THE INVENTION

The present invention relates to an EMI (electromagnetic interference) suppressing cable, and in particular to an EMI suppressing cable, in a controlling cable incorporated in various electronic devices, including a ferrite compound-mixed covering layer which covers core wires with insulative layers. The ferrite compound-mixed covering layer has an EMI noise canceling function per each of the core wires covered with the insulative layers.

Recently, for suppressing interference of electromagnetic waves (EMI), as shown in FIG. 3, a ferrite core 2 mounted on the way of a cable 1 is known. Also, a ferrite core 2 is mounted near a connector 3, and in addition ferrite cores are in general plural for increasing the EMI suppressing effect. External EMI noises are suppressed from invasion by covering an outside part of the cable 1. At the same time, radiation of EMI noise from a signal conductor toward an outside is suppressed. Further, the related art has equipped interior electronic parts, for example, ferrite bead chips or coils as countermeasures to EMI noise, or provided such as shields at a portion of an electronic circuit for enhancing the countermeasure to EMI noise.

However, the outside mounting of the ferrite core 2 has been not only troublesome but also restrained because of increasing the mounting spaces and weight, and caused cost-up similarly to addition of the internal electronic parts or shielding on the portion of the electronic circuit.

Therefore, for dissolving such inconveniences, as shown in FIG. 4, JP-A-6-203652 discloses a shielded cable 8 in which a first insulating layer 5 around core wires 4, a shielding layer 6 and a second insulating layer 7 are alternately laminated. Also, an amorphous magnetic tape 9 is wound on at least one part of an outer circumference of the second insulating layer 7. (For example, JP-A-6-203652, page 1 to 4, FIGS. 1 and 2)

The cable disclosed in JP-A-6-203652 has advantageous with respect to restrictions such as the mounting space and weight in comparison with the related cable having the ferrite core. However, the suppressing effect of EMI noise is very low since a base tape of the amorphous magnetic tape composing the amorphous magnetic substance is made of polyester or PPS (polyphenylene sulfide). Also, the amorphous magnetic tape is also wound around only one portion of the second insulating layer.

### SUMMARY OF THE INVENTION

It is therefore an object of the present invention to provide an EMI suppressing cable capable of properly maintaining the suppressing effect of EMI noise and decreasing in cost.

In order to achieve the above object, according to the present invention, there is provided an EMI suppressing cable, comprising:

a core wire bundle, including:

a plurality of core wires, respectively covered with insulative covering layers; and

ferrite compound-mixed resin layers, respectively covering the insulative covering layers;

a shielding layer, covering the core wire bundle; and

a sheath layer, covering the shielding layer.

Preferably, the insulative covering layers and the ferrite compound-mixed covering layers are formed by an extrusion formation.

Preferably, the shielding layer is comprised of at least a metal-braided wire layer, a metal tape layer and a mesh metal mixed resin.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 shows a perspective view of the EMI suppressing cable, according to one embodiment of the invention;

FIG. 2 shows an enlarged vertically cross sectional view of the core wire of FIG. 1;

FIG. 3 shows a side view of the related EMI suppressing cable; and

FIG. 4 shows a side view of another related EMI suppressing cable.

### DETAILED DESCRIPTION OF THE PREFERRED EMBODIMENTS

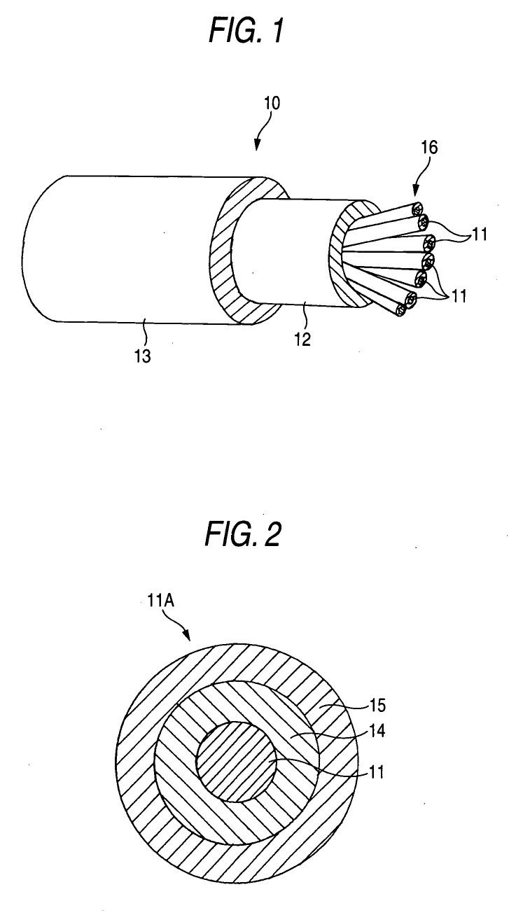

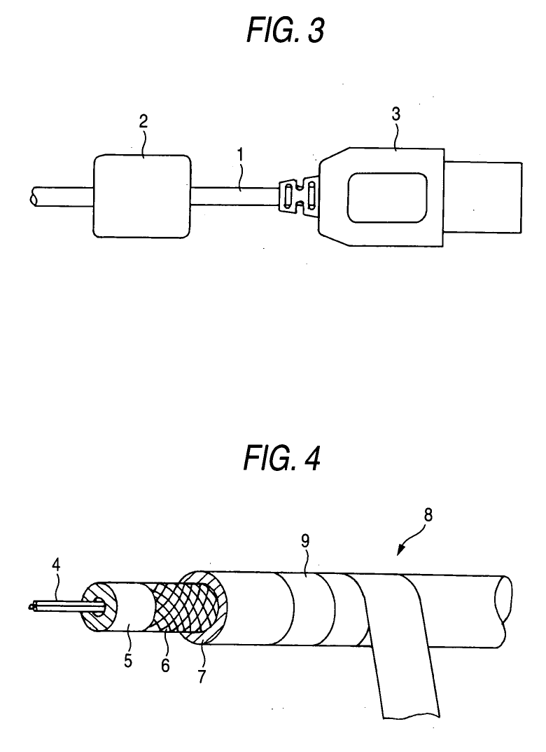

In the following description, one embodiment of the invention will be explained in detail, referring to FIGS. 1 and 2. FIGS. 1 and 2 show an EMI suppressing cable 10. The EMI suppressing cable 10 includes a core wire bundle 16, a shielding layer 12 for shielding the core wire bundle 16, and an outer sheath layer 13 called as a sheath layer covered on the shielding layer 12.

A core wire 11 is surrounded with an insulative covering layer 14 at an outer circumference thereof. The core wires 11 covered with the insulative covering layers 14 are covered with ferrite compound-mixed resin layers 15 respectively so that core wires 11A having ferrite compound-mixed covering layers are formed. A plurality of core wires 11A having the ferrite compound-mixed covering layers are in a bundle to form the core wire bundle 16. The outer circumference of the core wire layer bundle 16 having the ferrite compound-mixed covering layer is covered with a shielding layer. Also, the outer circumference of the shielding layer is covered with a sheath layer.

In addition, the core wire 11 is composed of a metal wire excellent in conductivity, such as copper or gold. The respective core wires 11 are covered with flexible insulating materials to avoid short circuit in relation with the adjoining core wires 11. However, no limitation should be made thereto, and a signal conductor may be composed only with the single core wire 11. Further, the insulative covering layer 14 as well as the ferrite compound-mixed covering layer 15, may be formed by an extrusion formation.

The shielding layer 12 formed on the outer circumference of the core wire bundle 16 having the ferrite compound mixed-covering layer also may be formed with a metal-braided wire layer, otherwise a metal tape layer or a mesh metal-mixed resin layer.

To state in more detail, the insulative covering layer 14 is formed on the outer circumference of the core wire 11 with a thermoplastic resin such as polyester resin or polyvinyl chloride resin, preferably formed by closely adhering on the outer circumference of the core wire 11 efficiently by the extrusion formation. Desirably, the resin is colored for being capable of distinguishing the core wires 11.

In the ferrite compound-mixed resin layer 15, ferrite powders are substantially evenly compounded in the resin. The ferrite compound-mixed resin layer 15 has large permeability and good frequency characteristic, and may exhibit the very high EMI suppressing force.

The shielding layer 12 is formed by such as a winding way of the conductive metal-braided wire layer, or the metal tape used in general on the outer circumference of the core wire bundle 16 having the ferrite compound-mixed covering layer, but being a flexible and conductive material, an arbitrary materials such as a metal foil may be selected.

The outer sheath layer 13 called as the sheath layer is preferably colored and formed with the resin as the polyester resin or polyvinylchloride resin on the outer circumference of the shielding layer 12 as the insulative covering layer of an outermost layer, that is, an outer covering in order to distinguish the respective EMI suppressing cables 10.

In the EMI suppressing cable 10 of the invention, each of the core wires 11 is covered with the insulative covering layer as shown in FIG. 1 so that core wires 11 having the insulative covering layer is formed. The ferrite compound-mixed resin layers is formed on the outer circumferences of the core wires 11 having the insulative covering layer. A plurality of the core wire 11A are bundled to form the core wire bundle 16. The shielding layer 12 is formed on the outer circumference of the core wire bundle 16, and beside the outer sheath layer 13 is formed on the outer circumference of the shielding layer 12 to be the cover.

The EMI suppressing cable 10 of the invention includes a step of respectively forming and covering the ferrite compound-mixed resin layers 15 on the insulative covering layers 14 covered on the respective core wires 11, and a step of forming the core wire bundle 16 by bundling the plurality of core wires 11 having the ferrite compound-mixed covering layers, and forming the shielding layers to be the cover on the outer circumference of the core wire bundle 16 and beside forming the outer sheath layer 13 on the outer circumference of the shielding layer 12 to be the cover. The EMI suppressing cable is, therefore, comparatively simple, so that productivity is increased at low cost, and the structure may be easily reduced in size, and is ready for incorporating in various kinds of electronic devices in company with good flexibility. Thus, according to the invention, the outside mounting of ferrite cores or the equipping of ferrite beads as internal electronic parts of the related art are any longer unnecessary.

Further, the insulative covering layer 14 is closely adhered to the outer circumferences of the core wires 11 through the extrusion formation. Also, the ferrite compound-mixed resin layer 15 are closely adhered to the insulative covering layer 14 through the extrusion formation. The extrusion formation may be covered well precisely and comparatively thin. Accordingly, the ferrite compound-mixed resin layers 15 enable to efficiently suppress EMI noise, and save expensive ferrite to the necessary minimum.

By the way, so far as not being beyond the spirit of the invention, various modifications are available, and of course, the invention comes up to the modifications.

As explained in detail in the embodiment, the EMI suppressing cable includes the core wire bundle having core wires respectively covered with the ferrite compound-mixed covering layers. Also, the shielding layer and the sheath layer are formed on the outer circumference of the core wire bundle. The shielding layer and each ferrite compound-mixed covering layer of the core wires have the EMI noise suppressing function, whereby the EMI noise suppressing function of the adjoining core wires at the cable center reaches over the full length of the cable, and is displayed very well efficiently. In addition, The shielding layer and the sheath layer protect the ferrite compound-mixed covering layers of the respective core wires from injuries to improve the reliability and durability of the EMI noise suppressing function. Furthermore, being comparatively simple in the structure, the production is easy, contributes to cost-down, heightens the size reduction and flexibility of the EMI suppressing cable, and makes easy incorporation in the electronic machinery. Thus, the invention can reply to needs of miniaturization of the electronic machinery and weight reduction.

Beside, the insulative covering layer and the ferrite compound-mixed covering layer formed on the outer circumference of each of the core wires are formed by the extrusion formation, the insulative covering layer and the ferrite compound-mixed covering layer can be precisely and easily provided on the outer circumference of each of the core wires.

The shielding layer on the outer circumference of the core wire bundle is formed with the resin layer having the mixture of the metal-braided wire layer otherwise the metal tape or a mesh metal line, so that the shielding layer is protected by the outer sheath layer and prevented from injuries as rapidly as possible, and at the same time, the ferrite compound-mixed covering layer of the core wire bundle is protected similarly, and the reliability and the durability of the EMI noise suppressing function of the cable in accordance with the invention are improved. The shielding layer is formed with the resin layer mixing the mesh metal line, thereby the adhesion with the mesh metal line and the resin is heightened, and the cable durability is more improved. As seen, the invention exhibits considerably various effects.

What is claimed is:

1. An EMI suppressing cable, comprising:
a core wire bundle, including:
a plurality of core wires, respectively covered with insulative covering layers; and
ferrite compound-mixed resin layers, respectively covering the insulative covering layers;
a shielding layer, covering the core wire bundle; and
a sheath layer, covering the shielding layer.

2. The EMI suppressing cable as set forth in claim 1, wherein the insulative covering layers and the ferrite compound-mixed covering layers are formed by an extrusion formation.

3. The EMI suppressing cable as set forth in claim 1, wherein the shielding layer is comprised of at least a metal-braided wire layer, a metal tape layer and a mesh metal mixed resin.
